(19) United States
(12) Patent Application Publication
(10) Pub. No.: US 2009/0282292 A1
(43) Pub. Date: Nov. 12, 2009

(54) METHODS, DEVICES AND COMPUTER PROGRAM PRODUCTS FOR AUTOMATIC FAULT IDENTIFICATION IN A NETWORK

(76) Inventor: Matthew B. Squire, Raleigh, NC (US)

Correspondence Address: MYERS BIGEL SIBLEY & SAJOVEC, PO BOX 37428, RALEIGH, NC, 27627, US

(21) Appl. No.: 12/463,594

(22) Filed: May 11, 2009

Related U.S. Application Data
(60) Provisional application No. 61/052,485, filed on May 12, 2008.

(51) Int. Cl. G06F 11/07; G06F 15/173

(52) U.S. Cl. 714/39; 709/224; 714/48; 714/E11.024

(57) ABSTRACT

Methods, devices and computer program products for identifying faults in a network include monitoring a plurality of wirelines at a central network unit for faults. The plurality of wirelines connect a respective plurality of network elements to the central network unit. If a fault is detected in one of the plurality of wirelines, the central network unit automatically initiates diagnostic measurement of characteristics of the wireline.

### RELATED APPLICATIONS

This application claims priority to U.S. Provisional Application No. 61/052,485 filed May 12, 2008, the contents of which are hereby incorporated by reference in their entirety.

### FIELD OF THE INVENTION

The present invention relates to the field of data communications, and more particularly, to methods, devices and computer program products for detecting device and/or wireline faults in a communications network.

### BACKGROUND

The maintenance of the end portion of wireline communications networks that is remote from a central office or control unit can be a time-consuming and/or expensive task. There are many different types of faults in an access network, with each type of fault having its own correction and recovery procedures. If a network element fails, it can be difficult to determine when, where and what type of fault occurred.

One well-known method for signaling a fault is a “dying gasp” feature, which allows a network element that is remote from the central office to send a message that indicates the imminent loss of power to the network element. The dying gasp is sent from the network element over the network to the central office. To perform this dying gasp signaling upon a power failure, the device generally includes some amount of electrical capacitance so that limited operations to signal a dying gasp can occur for a brief period of time after power failure is locally detected. A dying gasp can be used, for example, in the last mile remote from the network operator's central office because power supplies and cabling can be far from the operator's control. If a connection is lost, but a dying gasp is not received by the central office, it may be assumed that a power failure did not occur and the fault was caused by other circumstances, such as failure in a wireline connection.

However, the dying gasp alarm signaling can be unreliable. The dying gasp message may not always be successfully sent through the network, and therefore, in some instances, the lack of receiving a dying gasp message from a network element may not necessarily indicate that a power failure did not occur. In addition, the dying gasp feature has an inherent cost in its implementation. For example, the network equipment is conventionally designed with extra electrical capacitance to ensure that the message can be sent. In order to provide sufficient time for the message to be sent, the equipment is generally designed with complex power management so that power utilization can be immediately reduced when the power fails so that the message may be successfully sent. This may use many extra circuits to shut off power consuming portions of the equipment that do not affect the fault signal transmission.

### SUMMARY OF EMBODIMENTS OF THE INVENTION

According to some embodiments of the invention, methods, devices and computer program products for identifying faults in a network include monitoring a plurality of wirelines at a central network unit for faults. The plurality of wirelines connect a respective plurality of network elements to the central network unit. If a fault is detected in one of the plurality of wirelines, the central network unit automatically initiates diagnostic measurement of characteristics of the wireline.

In some embodiments, an operational wireline fault profile for the plurality of wirelines is generated. The wireline profile can include a time domain reflectometer (TDR) and/or single ended loop testing (SELT) result performed when one of the plurality of network elements is operatively connected to the central network unit via a respective one of the plurality of wirelines. A fault analysis report can be generated including a comparison between the operational wireline fault profile and the diagnostic measurement after the fault in one of the wirelines is detected.

In some embodiments, the operational wireline fault profile can be communicated to a management system, e.g., via simple network management protocol (SNMP). In particular embodiments, the plurality of wirelines are monitored for faults by detecting a fault in a wireline that is devoid of a dying gasp from one of the plurality of network elements.

In some embodiments, a fault analysis report is generated including the measured characteristics of the wireline. The diagnostic measurement can be analyzed to determine characteristics of a fault, including an identification of a connected network element without power, a short circuit in a wireline, an open circuit in a wireline and/or a location of the fault.

In some embodiments, a fault is detected when the central network unit detects a line fault and/or lack of connection to a network element on a wireline.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a block diagram that illustrates a computer network system according to some embodiments of the present invention.

FIG. 2 is a block diagram that illustrates a software architecture for detecting faults and automatically initiating diagnostic measurements of wirelines in a computer network system according to some embodiments of the present invention.

FIG. 3 is a flow chart illustrating operations for detecting faults and automatically initiating diagnostic measurements of wirelines in a computer network according to some embodiments of the present invention.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

The present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory) and a portable compact disc read-only memory (CD-ROM).

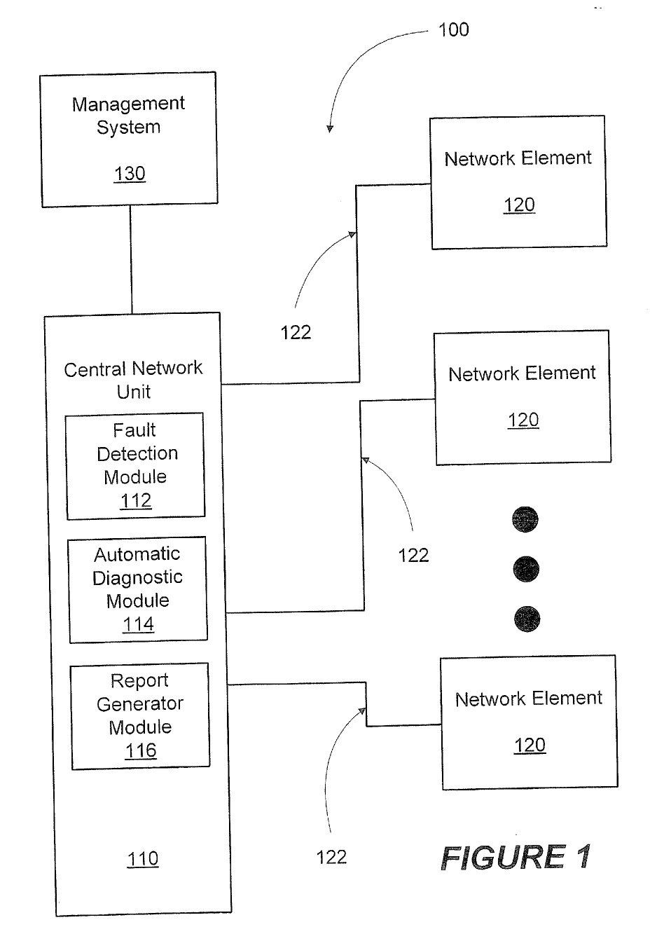

FIG. 1 illustrates a computer network system 100 having a central network unit 110, a plurality of network elements 120, and a management system 130. The central network unit 110 includes a fault detection module 112, an automatic diagnostic module 114, and a report generator module 116. The network elements 120 are connected to the central network unit 110 by wirelines 122.

In some embodiments, the central network unit 110 is configured to provide data services, such as voice and/or digital subscriber line (DSL) services to the plurality of network elements 120. The network elements 120 can be devices that support data services to an end user. Exemplary network elements 120 include subscriber/user personal computers, modems, set-top boxes and other network devices for providing data services to a subscriber. In some embodiments, the wirelines 122 are standard telephony cabling used to carry voice and/or digital subscriber line (DSL) services, which can be provided and/or monitored by the central network unit 110. It will be understood, however, that the present invention is not limited to the standard telephony cabling, and other communication standards that support the operations described herein may also be used in further embodiments of the present invention.

Although as shown in FIG. 1, the wirelines 122 are directly connected to the central network unit 110, it should be understood that the wirelines can be connected by an intermediate interface, such as being patched through a main distribution frame (MDF) or via other devices/interfaces.

The fault detection module 112 of the central network unit 110 is configured to monitor the wirelines 122 and to detect faults in the wirelines 122. The wireline faults can be detected using various techniques, e.g., by detecting faults at the physical layer via DSL characteristics such as synchronization, margin, coding errors, etc. or by detecting faults in the higher layer operations, administration and maintenance (OAM) protocols. In particular embodiments, the fault detection module 112 can detect a fault in one of the wirelines 122 without requiring the detection of a dying gasp or a signal that is actively sent from one of the network elements 120. For example, the fault detection module 112 can detect a fault by detecting a fault in a wireline 122 (e.g., a short circuit) and/or a lack of communicative connection to a network element 120.

If a fault is detected, then the automatic diagnostic module 114 of the central network unit 110 automatically initiates a diagnostic measurement of characteristics of the wireline using a time domain reflectometer (TDR) and/or single ended loop testing (SELT). The report generator module 116 can generate a report of the diagnostic measurement and can communicate the diagnostic report to the management system 130, for example, via simple network management protocol (SNMP).

As used herein, a time domain reflectometer (TDR) is a test function that measures characteristics of a wire by initiating a pulse down a wire and measuring the signals and/or echoes that return to the testing point. A time domain reflectometer (TDR) may be used on outside plant telephony cabling, such as the wirelines 122 shown in FIG. 1. A time domain reflectometer (TDR) can be used to isolate a variety of faults, including open wiring, short-circuited wiring and devices connected to the wiring, including bridge taps, load coils, remote modems, etc. In some instances, a time domain reflectometer (TDR) can be used to identify a particular piece of equipment connected to the wire via its reflection signature or operational wireline fault profile. A time domain reflectometer (TDR) can also be used to isolate a location of the fault. Thus, a time domain reflectometer (TDR) can include a catalog of known operational wireline fault profiles used to identify a variety of connected equipment. In some instances, connected network elements may have a different operational wireline fault profile based on the status of the network element. For example, a network element that is not receiving power may have a different operational wireline fault profile than an element that has a high quality power input.

Single ended loop testing (SELT) is a term from digital subscriber line (DSL) standards indicating a set of testing functions by which one end of a line can run tests on the line independent of the network element on the remote end of the wireline. Single ended loop testing (SELT) tests may include a time domain reflectometer (TDR) capability, which can be integrated with a modem or in a separate part of the network element outside of a network element modem and shared across many lines. Single ended loop testing (SELT) tests can also provide other functions, such as frequency testing and/or spectrum testing to provide additional details on specific disturbances impacting performance.

In particular embodiments, the automatic diagnostic module 114 can test the wirelines 122 and/or network elements 120 using a time domain reflectometer (TDR) and/or single ended loop testing (SELT) to generate an operational wireline fault profile when the network elements 120 are known to be operatively connected to the central network unit 110. The operational wireline fault profile can be used to diagnose connection faults, for example, by comparing the operational wireline fault profile with a time domain reflectometer (TDR) and/or single ended loop testing (SELT) test on a wireline when a fault has occurred. The operational wireline fault profile can be communicated to the management system 130, e.g., via simple network management protocol (SNMP). In some embodiments, raw time domain reflectometer (TDR) or single ended loop testing (SELT) data can be automatically analyzed and/or interpreted to determine an appropriate course of action to correct a fault, such as contact the incumbent operator to repair the line, send a repair crew, and/or contact the power company or customer regarding the power supply.

Although FIG. 1 illustrates exemplary fault detection/monitoring modules in a central network unit 110, in accordance with some embodiments of the present invention, it will be understood that the present invention is not limited to such a configuration but is intended to encompass any configuration capable of carrying out operations described herein. For example, the fault detection module 112, the automatic diagnostic module 114, the report generator module 116 and/or the management system 130 can be provided as part of the same device or may be provided on different devices.

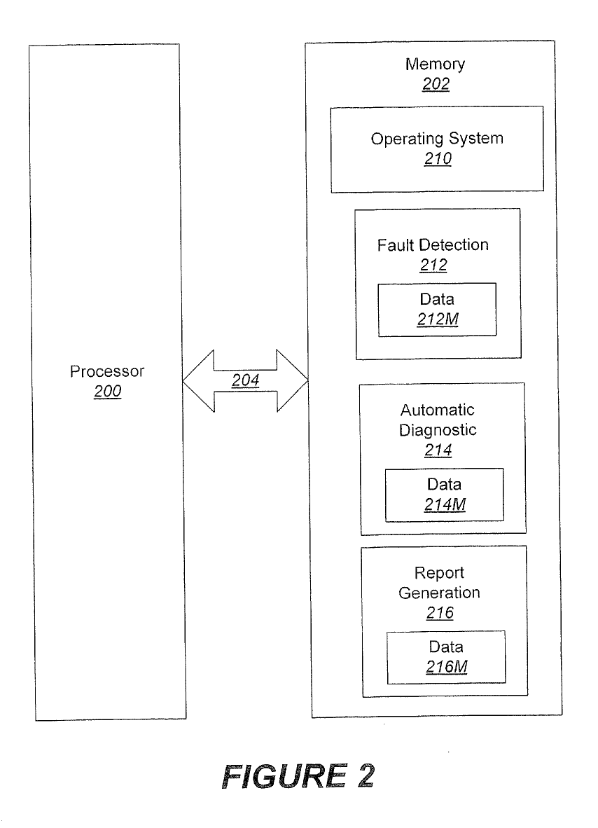

FIG. 2 illustrates a processor 200 and memory 202 that may be used in embodiments of central network or control units, such as, for example, the central network unit 110 of FIG. 1, in accordance with embodiments of the present invention. The processor 200 communicates with the memory 202 via an address/data bus 204. The processor 200 may be, for example, a commercially available or custom microprocessor. The memory 202 is representative of the one or more memory devices containing the software and data used to facilitate fault detection, fault diagnosis and/or fault report generation in accordance with some embodiments of the present invention. The memory 202 may include, but is not limited to, the following types of devices: cache, ROM, PROM, EPROM, EEPROM, flash, SRAM, and DRAM.

As shown in FIG. 2, the memory 202 may contain various categories of software and/or data: an operating system 210, a fault detection module 212, an automatic diagnostic module 214, and a report generation module 216. The operating system 210 generally controls the operation of the central network unit. In particular, the operating system 210 may manage the central network unit's software and/or hardware resources and may coordinate execution of programs by the processor 200. The fault detection module 212 can be configured to determine faults on the wirelines 122 (FIG. 1). Upon detection of a fault, the automatic diagnostic module 214 is configured to automatically initiate diagnostic measurement of characteristics of the wireline at the central network unit using a time domain reflectometer (TDR) and/or single ended loop testing (SELT). The report generation module 216 is can be configured to generate a report based on the measured characteristics of the wireline from the automatic diagnostic module 214.

To assist in performing these functions, the fault detection module 212, the automatic diagnostic module 214, and the report generation module 216 include data modules 212M, 214M and 216M, respectively. These data modules 212M, 214M and 216M may represent software data structures, such as arrays, lists, tables, and/or hash tables. For example, data module 212M of the fault detection module 212 can include fault parameters used to identify when a fault has occurred and/or data obtained by monitoring signals received from the wirelines 122 (FIG. 1). The data module 216M of the report generation module 216 can include analysis of the measured diagnostic characteristics of the fault on a wireline, such as the fault type (e.g., open circuit, short circuit, whether the remote network element is connected and/or powered), the fault distance indicating how far from the central network unit 110 (FIG. 1) the fault exists, etc. In particular embodiments, the data module 216M includes prior single ended loop testing (SELT) and/or a time domain reflectometer (TDR) test results taken when wireline(s) 122 were known to be operatively connected to a properly functioning network element 120 (FIG. 1). Thus, the report generation module 216 can compare the single ended loop testing (SELT) and/or a time domain reflectometer (TDR) test results with operational wireline(s) 122/network element(s) 120 to single ended loop testing (SELT) and/or a time domain reflectometer (TDR) results after a fault. In some embodiments, the report generation module 216 can communicate data in a report (such as fault type, distance to fault, and/or comparisons with functional single ended loop testing (SELT) and/or a time domain reflectometer (TDR) data) to the management system 130 of FIG. 1, for example, as an alarm indication and/or with suggested repair options.

Although FIG. 2 illustrates exemplary fault detection/monitoring software architecture in accordance with some embodiments of the present invention, it will be understood that the present invention is not limited to such a configuration but is intended to encompass any configuration capable of carrying out operations described herein.

Computer program code for carrying out operations of fault detection devices discussed above with respect to FIG. 2 may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, systems, and computer program products in accordance with exemplary embodiments of the invention. These flowchart and/or block diagrams further illustrate exemplary operations of identifying and/or automatically diagnosing faults in a network element and/or wireline, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

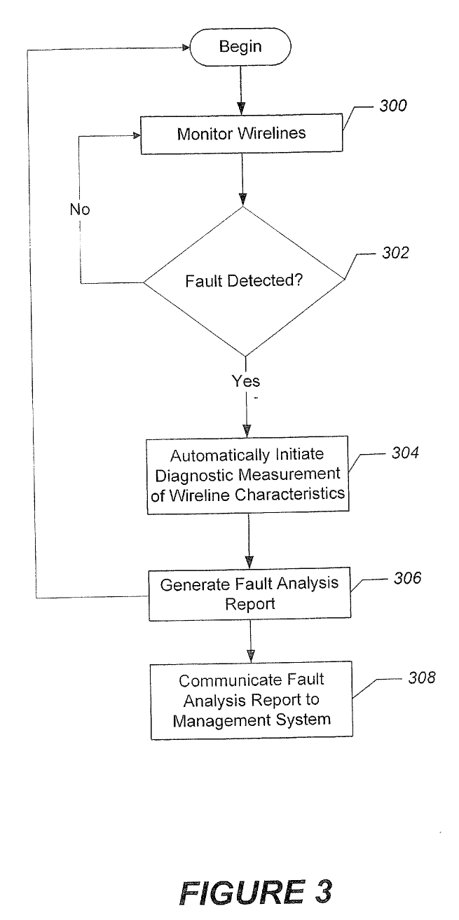

Referring now to FIG. 3, exemplary operations for fault detection and diagnosis are described. With reference to FIGS. 1-3, wirelines are monitored to detect faults (Block 300; FIG. 3), for example, using the fault detection module 112/212 of the central network unit 110. The wireline faults can be detected using various techniques, e.g., by detecting a line fault and/or lack of connection to a network element, faults at the physical layer via DSL characteristics such as synchronization, margin, coding errors, etc. or by detecting faults in the higher layer operations, administration and maintenance (OAM) protocols. In some embodiments, the fault can be detected in a wireline 122 without receiving a dying gasp from one of the network elements 120 (FIG. 1), e.g., in a wireline 122 that is devoid of a dying gasp or other signal generated by the network element 120.

If a fault is detected (Block 302; FIG. 3), then the automatic diagnostic module 114/214 of the central network unit 110 automatically initiates a diagnostic measurement of characteristics of the wireline using a time domain reflectometer (TDR) and/or single ended loop testing (SELT) (Block 304; FIG. 3). In some embodiments, the initiation of the diagnostic measurement of characteristics of the wireline can be delayed. When a line is being tested it may not be able to support user traffic and/or data. Therefore, it may be desirable to wait some period of time to allow the wireline to potentially correct itself, and only test the wireline if after it fails to reinitialize.

The report generator module 116/216 can generate a report of the diagnostic measurement (Block 306; FIG. 3) and can communicate the diagnostic report to the management system 130. In some embodiments, the diagnostic report can include a comparison between the diagnostic measurement after a fault has occurred and an operational wireline fault profile. The diagnostic report can include an analysis of characteristics of a fault, such as an identification of a connected network element without power, a short circuit in a wireline, an open circuit in a wireline and/or a location of the fault. Recommended fault corrective actions can also be provided based on the fault analysis report. In some embodiments, the fault analysis report can be communicated specifically via simple network management protocol (SNMP) traps and/or alarms in a standard fault management structure. For example, the fault analysis report can be communicated to the management system 130 (Block 308; FIG. 3).

According to some embodiments of the present invention, the central network unit 110 can determine faults in wirelines 122 without requiring any additional features in the network elements 120, such as additional circuitry that is typically used with dying gasp functions. Moreover, the faults can be detected without necessarily requiring a failing network element 120 to perform active fault signaling.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of identifying faults in a network, the method comprising:
monitoring a plurality of wirelines at a central network unit for faults, wherein the plurality of wirelines connect a respective plurality of network elements to the central network unit; and
if a fault is detected in one of the plurality of wirelines, automatically initiating diagnostic measurement of characteristics of the wireline at the central network unit.

2. The method of claim 1, further comprising generating an operational wireline fault profile for the plurality of wirelines, the wireline profile comprising a time domain reflectometer (TDR) and/or single ended loop testing (SELT) result performed when one of the plurality of network elements is operatively connected to the central network unit via a respective one of the plurality of wirelines.

3. The method of claim 2, further comprising generating a fault analysis report comprising a comparison between the operational wireline fault profile and the diagnostic measurement after the fault in one of the wirelines is detected.

4. The method of claim 1, further comprising generating a fault analysis report comprising the measured characteristics of the wireline.

5. The method of claim 1, wherein automatically initiating diagnostic measurement of characteristics of the wireline at the central network unit is performed using a time domain reflectometer (TDR) and/or single ended loop testing (SELT).

6. The method of claim 1, further comprising analyzing the diagnostic measurement to determine characteristics of a fault, wherein the characteristics of the fault include an identification of a connected network element without power, a short circuit in a wireline, an open circuit in a wireline and/or a location of the fault.

7. The method of claim 1, wherein a fault is detected when the central network unit detects a line fault and/or lack of connection to a network element on a wireline.

8. The method of claim 2, further comprising communicating the operational wireline fault profile to a management system.

9. The method of claim 8, wherein the operational wireline fault profile is communicated via simple network management protocol (SNMP).

10. The method of claim 1, wherein monitoring the plurality of wirelines for faults comprises detecting a fault in a wireline that is devoid of a dying gasp from one of the plurality of network elements.

11. A device for identifying faults in a network, the device comprising:
a central network unit configured to monitor a plurality of wirelines for faults, wherein the plurality of wirelines are configured to connect a respective plurality of network elements to the central network unit;
wherein the central network unit is configured to automatically initiate diagnostic measurement of characteristics of the wireline if a fault is detected in one of the plurality of wirelines.

12. The device of claim 11, wherein the central network unit is configured to generate an operational wireline fault profile for the plurality of wirelines, the wireline profile comprising a time domain reflectometer (TDR) and/or single ended loop testing (SELT) result performed when one of the plurality of network elements is operatively connected to the central network unit via a respective one of the plurality of wirelines.

13. The device of claim 12, wherein the central network unit is configured to generate a fault analysis report comprising a comparison between the operational wireline fault profile and the diagnostic measurement after the fault in one of the wirelines is detected.

14. The device of claim 11, wherein the central network unit is configured to generate a fault analysis report comprising the measured characteristics of the wireline.

15. The device of claim 11, wherein the central network unit is configured to automatically initiate the diagnostic measurement of characteristics of the wireline at the central network unit using a time domain reflectometer (TDR) and/or single ended loop testing (SELT).

16. The device of claim 11, wherein the central network unit is configured to analyze the diagnostic measurement to determine characteristics of a fault, wherein the characteristics of the fault include identification of a connected network element without power, a short circuit in a wireline, an open circuit in a wireline and/or a location of the fault.

17. The device of claim 11, wherein the central network unit is configured to detect a fault when the central network unit detects a line fault and/or lack of connection to a network element on a wireline.

18. The device of claim 12, wherein the central network unit is configured to communicate the operational wireline fault profile to a management system.

19. The device of claim 18, wherein the central network unit is configured to communication the operational wireline fault profile to a management system via simple network management protocol (SNMP).

20. The device of claim 11, wherein the central network unit is configured to automatically initiate the diagnostic measurement of characteristics of the wireline at the central network unit using a time domain reflectometer (TDR) and/or single ended loop testing (SELT).

21. A computer program product for identifying faults in a network, computer program product comprising:
a computer readable storage medium having computer readable program code embodied therein, the computer readable program code comprising:
computer readable program code configured to monitor a plurality of wirelines at a central network unit for faults, wherein the plurality of wirelines connect a respective plurality of network elements to the central network unit; and
computer readable program code configured to automatically initiate diagnostic measurement of characteristics of the wireline at the central network unit in response to detecting a fault in one of the plurality of wirelines.

22. The computer program product of claim 21, further comprising computer readable program code that is configured to generate an operational wireline fault profile for the plurality of wirelines, the wireline profile comprising a time domain reflectometer (TDR) and/or single ended loop testing (SELT) result performed when one of the plurality of network elements is operatively connected to the central network unit via a respective one of the plurality of wirelines.

23. The computer program product of claim 22, further comprising computer readable program code that is configured to generate a fault analysis report comprising a comparison between the operational wireline fault profile and the diagnostic measurement after the fault in one of the wirelines is detected.

24. The computer program product of claim 21, further comprising computer readable program code that is configured to generate a fault analysis report comprising the measured characteristics of the wireline.

25. The computer program product of claim 21, wherein the computer readable program code that is configured to automatically initiate diagnostic measurement of characteristics of the wireline at the central network unit further comprises computer readable program code that is configured to automatically initiate diagnostic measurement of characteristics of the wireline using a time domain reflectometer (TDR) and/or single ended loop testing (SELT).

26. The computer program product of claim 21, further comprising computer readable program code that is configured to analyze the diagnostic measurement to determine characteristics of a fault, wherein the characteristics of the fault include an identification of a connected network element without power, a short circuit in a wireline, an open circuit in a wireline and/or a location of the fault.

27. The computer program product of claim 21, further comprising computer readable program code that is configured to detect a fault by detecting, at the central network unit, a line fault and/or lack of connection to a network element on a wireline.

28. The computer program product of claim 22, further comprising computer readable program code that is configured to communicate the operational wireline fault profile to a management system.

29. The computer program product of claim 28, wherein the computer readable program code that is configured to communicate the operational wireline fault profile to the management system further comprises computer readable program code that is configured to communicate the operational wireline fault profile to the management system via simple network management protocol (SNMP).

30. The computer program product of claim 21, wherein the computer readable program code configured to monitor the plurality of wirelines for faults comprises computer readable program code configured to detect a fault in a wireline that is devoid of a dying gasp from one of the plurality of network elements.
